(19) United States
(12) Patent Application Publication
(10) Pub. No.: US 2021/0341887 A1
(43) Pub. Date: Nov. 4, 2021

(54) INFORMATION PROCESSING DEVICE AND INFORMATION PROCESSING METHOD

(71) Applicant: Hitachi, Ltd., Tokyo (JP)

(72) Inventors: Yuya OKADOME, Tokyo (JP); Toshiko AIZONO, Tokyo (JP)

(21) Appl. No.: 17/186,233

(22) Filed: Feb. 26, 2021

(30) Foreign Application Priority Data
Apr. 30, 2020 (JP) 2020-079937

(51) Int. Cl. G05B 13/04; G05B 13/02; G06K 9/62

(52) U.S. Cl. CPC G05B 13/042; G06K 9/6277; G06K 9/6257; G05B 13/0265

(57) ABSTRACT

To provide an information processing device capable of more efficiently searching for parameters. An optimization portion selects a search area, namely, any of the multiple subspaces contained in a parameter space composed of multiple parameters based on evaluation result information indicating an evaluation value that evaluates a processing result of information processing based on each trial parameter by using the trial parameter. The optimization portion allows a classification model portion to perform information processing using the trial parameter, namely, any one of parameters belonging to the search area. The optimization portion repeats a search process to update the evaluation result information based on the processing result of the information processing.

### CROSS-REFERENCE TO RELATED APPLICATION

The present application claims priority from Japanese application JP 2020-079937, filed on Apr. 30, 2020, the contents of which is hereby incorporated by reference into this application.

### BACKGROUND

The present disclosure relates to an information processing device and an information processing method.

Information processing such as machine learning and simulation involves parameters that require adjustment from the outside. The adjustment of this kind of parameters depends on the user's experience and skill. Machine learning uses chronological data whose tendency gradually changes, making it necessary to frequently adjust parameters. Users bear a great burden of work. Simulations such as plant control require fine-tuning the parameter values. An increase in the number of parameters makes appropriate adjustments difficult.

For example, there are known grid search and random sampling as methods of searching for appropriate parameters. However, the grid search method searches for parameters in a round-robin manner and requires a very long calculation time. The random sampling method randomly searches for values available to parameters and often fails in finding appropriate parameters, degrading the accuracy.

Further, there is known a method of Bayesian optimization that achieves high accuracy by biasing the procedure of the random sampling method to search for values (see Emile Contal and two others, “Gaussian Process Optimization with Mutual Information,” Proceedings of 31th International Conference on Machine Learning, China, 2014, pages 253-261). The Bayesian optimization first selects parameters based on prepared acquisition functions and then performs predetermined information processing by using the selected parameters. The method calculates an evaluation value that evaluates the accuracy of a processing result of the information processing. This procedure is repeated to search for optimal parameters.

### SUMMARY

However, the Bayesian optimization takes time to search for an optimum parameter when the parameter space contains many so-called troughs where an evaluation value is lower than the others.

It is an object of the present disclosure to provide an information processing device and an information processing method capable of efficiently searching for parameters.

An information processing device according to an aspect of the present disclosure searches for an available parameter used for predetermined information processing and includes an information processing portion and a search portion. The information processing portion performs the information processing. The search portion selects a search area, namely, one of multiple subspaces included in a parameter space composed of multiple parameters based on evaluation result information indicating an evaluation value to evaluate a processing result of the information processing based on each trial parameter by using the trial parameter. The search portion allows the information processing portion to perform the information processing by using any of parameters belonging to the search area as the trial parameter. The search portion repeats a search process to update the evaluation result information based on a processing result of the information processing.

The present invention makes it possible to more efficiently search for parameters.

### BRIEF DESCRIPTION OF THE DRAWINGS

FIG. 1 is a diagram illustrating a functional structure of the information processing device according to an embodiment of the present invention;

FIG. 2 is a diagram illustrating a functional structure of an optimization portion;

FIG. 3 is a diagram illustrating a functional structure of an area selection portion;

FIG. 4 is a diagram illustrating a parameter condition;

FIG. 5 is a diagram illustrating evaluation result information;

FIG. 6 is a flowchart illustrating a process performed by the information processing device;

FIG. 7 is a flowchart illustrating a parameter optimization process;

FIG. 8 is a flowchart illustrating a parameter condition conversion process;

FIG. 9 is a flowchart illustrating an area selection portion process;

FIG. 10 is a diagram illustrating a display screen;

FIG. 11 is a partially enlarged view of the display screen illustrated in FIG. 10;

FIG. 12 is a diagram illustrating another example of the display screen;

FIG. 13 is a partially enlarged view of the display screen illustrated in FIG. 12;

FIG. 14 is a diagram illustrating another example of the display screen; and

FIG. 15 is a partially enlarged view of the display screen illustrated in FIG. 14.

### DETAILED DESCRIPTION

An embodiment of the present invention will be described with reference to the accompanying drawings.

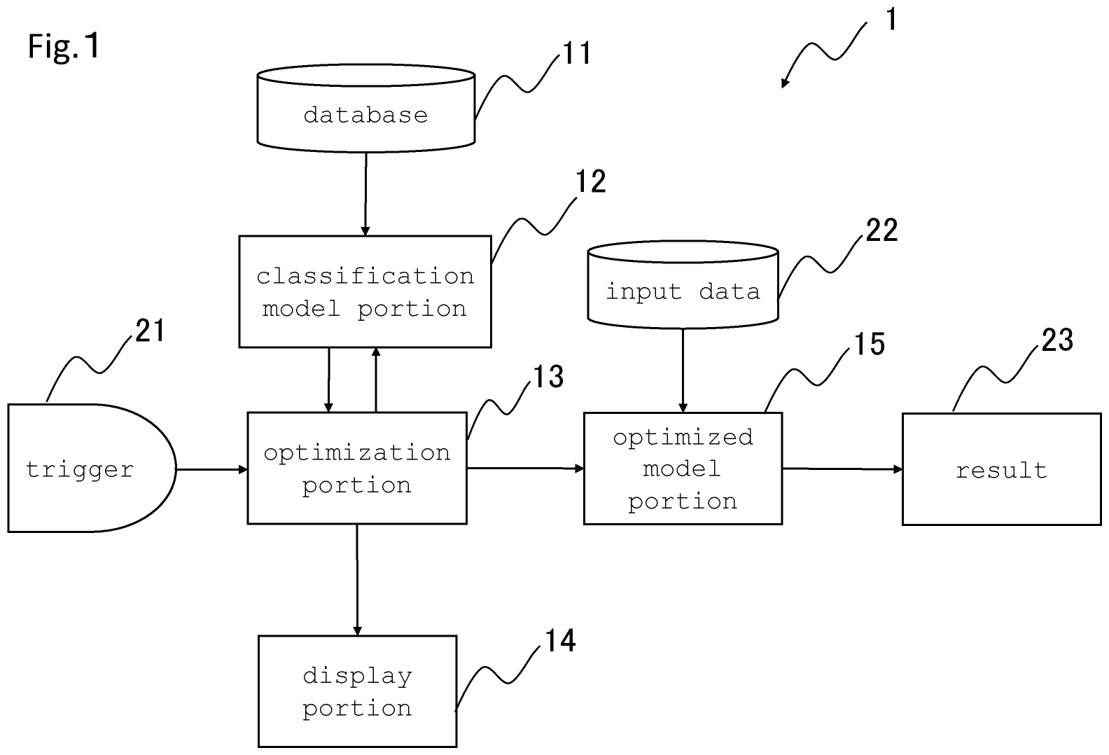

FIG. 1 is a diagram illustrating a functional structure of the information processing device according to an embodiment of the present invention. An information processing device 1 illustrated in FIG. 1 includes a database 11, a classification model portion 12, an optimization portion 13, a display portion 14, and an optimized model portion 15.

The database 11 stores various types of data input to the classification model portion 12.

The classification model portion 12 is comparable to an information processing portion that generates a predetermined model by executing machine learning as predetermined information processing based on data input from the database 11. According to the present embodiment, the predetermined model is assumed to be a classification model to classify input data but may represent other models. Machine learning includes multiple parameters (hyperparameters) that need to be determined in advance before executing the machine learning.

The optimization portion 13 starts the operation according to a predetermined trigger 21 and performs a parameter optimization process that allows the classification model portion 12 to determine parameters of machine learning.

The display portion 14 displays various information such as processing results and intermediate results of the optimization portion 13.

The optimized model portion 15 executes an optimization model, namely, a classification model generated by machine learning based on the parameters determined by the optimization portion 13, classifies input data 22, and outputs the classification result as a result 23.

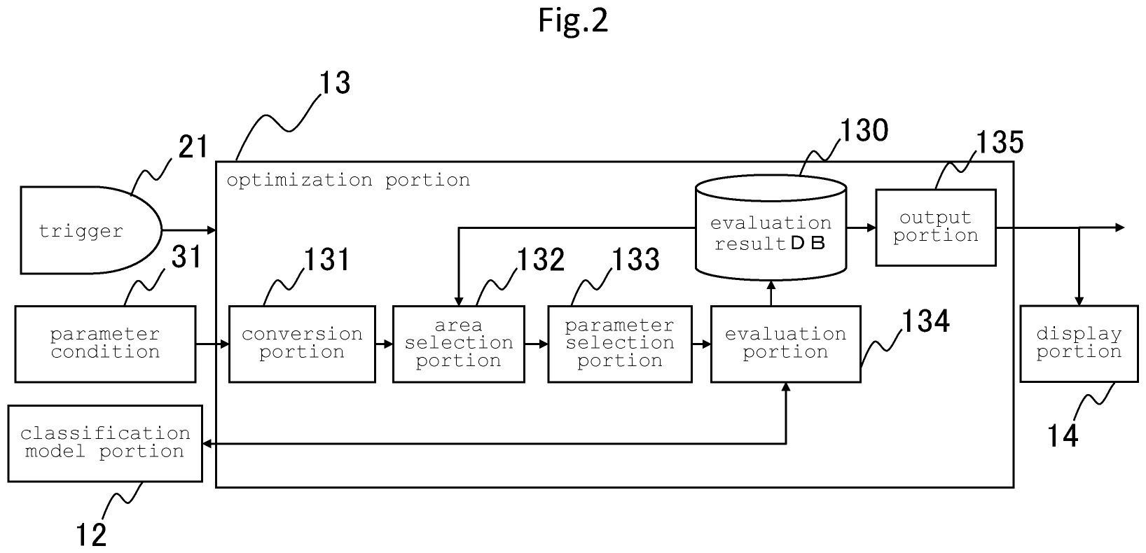

FIG. 2 is a diagram illustrating a functional structure of the optimization portion 13. The optimization portion 13 illustrated in FIG. 2 includes an evaluation result database (DB) 130, a conversion portion 131, an area selection portion 132, a parameter selection portion 133, an evaluation portion 134, and an output portion 135.

The evaluation result database 130 is comparable to a storage portion to store evaluation result information representing an evaluation value that evaluates a processing result of machine learning performed by the classification model portion 12 based on each trial parameter used for the tried machine learning.

The conversion portion 131 performs a parameter condition conversion process to generate a candidate parameter generator based on a parameter condition 31 as information about machine learning parameters. The candidate parameter generator generates a candidate parameter as a candidate for the parameter (trial parameter) used for the machine learning tried by the classification model portion 12. The parameter condition 31 may be stored in the information processing device 1 or may be input from the outside, for example.

Based on the evaluation result information stored in the evaluation result database 130, the area selection portion 132 selects one of the multiple areas (subspaces) as a search area to search for the trial parameter. Those areas are included in a parameter space composed of the parameters for machine learning performed by the classification model portion12. The area selection portion 132 uses the candidate parameter generator generated by the conversion portion 131 to generate a set of parameters in the search area as a set of candidate parameters.

The parameter selection portion 133 selects the trial parameter from the set of candidate parameters generated by the area selection portion 132. The trial parameter is configured for machine learning and allows machine learning to be tried.

The evaluation portion 134 allows the classification model portion 12 to perform machine learning based on the trial parameter selected by the parameter selection portion 133 and calculates an evaluation value that evaluates the classification model as a processing result of the machine learning. The evaluation portion 134 correlates the trial parameter with the evaluation value to provide the evaluation result information that is then added to the evaluation result database 130.

The output portion 135 outputs information based on the evaluation result information stored in the evaluation result database 130. The information output from output portion 135 is displayed on the display portion 14, for example.

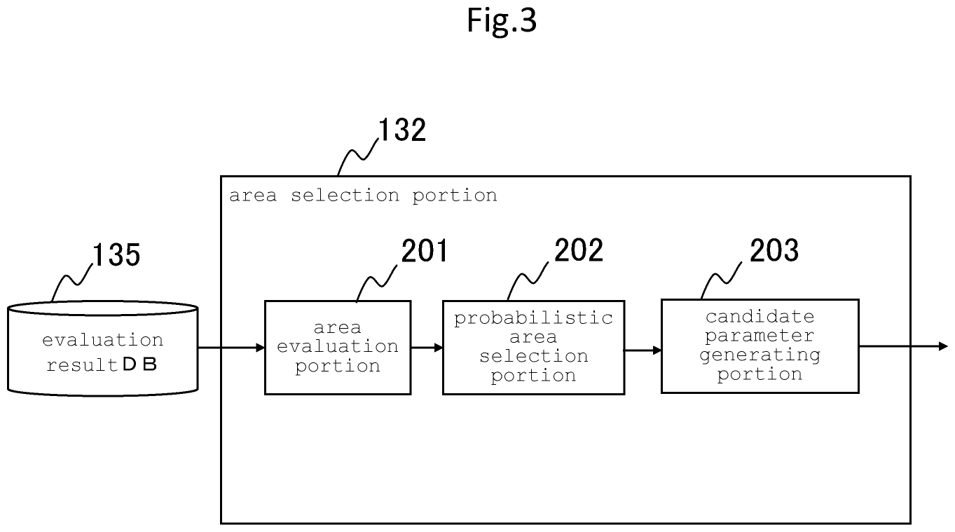

FIG. 3 is a diagram illustrating a functional structure of the area selection portion 132. The area selection portion 132 in FIG. 3 includes an area evaluation portion 201, a probabilistic area selection portion 202, and a candidate parameter generating portion 203.

Based on the evaluation result information stored in the evaluation result database 130, the area evaluation portion 201 calculates an area evaluation value that evaluates each of the multiple areas included in the parameter space composed of parameters for machine learning performed by the classification model portion 12.

The probabilistic area selection portion 202 selects one of those areas as the search area based on the area evaluation value for each area according to the area evaluation portion 201. Specifically, the probabilistic area selection portion 202 provides each area with a selection probability based on the area evaluation value for each area and selects the search area according to the selection probability.

The candidate parameter generating portion 203 uses the candidate parameter generator generated by the conversion portion 131 to generate a set of parameters in the search area as a set of candidate parameters.

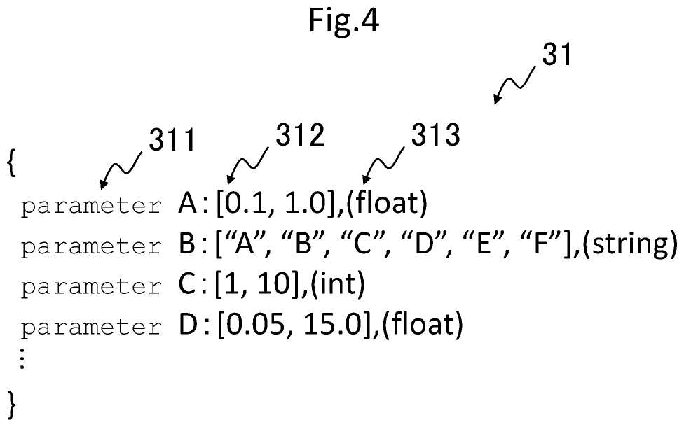

FIG. 4 is a diagram illustrating the parameter condition 31. The parameter condition 31 illustrated in FIG. 4 indicates identification information 311 to identify the parameter, a parameter range (available values) 312, and a parameter type (data type) 313 for each machine learning parameter. For example, the parameter range 312 indicates the minimum and maximum values when the parameter type 313 is a numeric value such as “integer type (int)” and “floating-point number type (float).” For example, the parameter range 312 indicates all available values as parameter values when the parameter type 313 is “string type (string).”

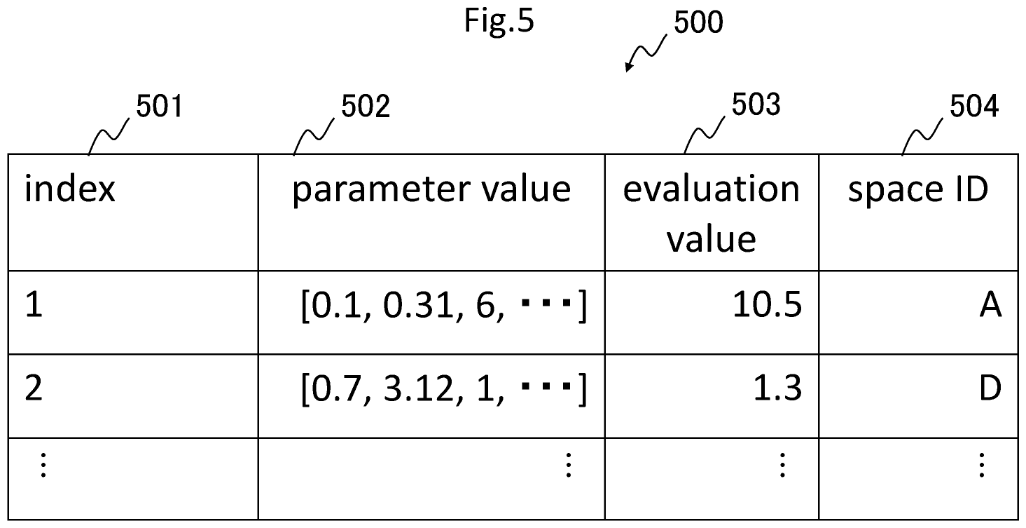

FIG. 5 is a diagram illustrating the evaluation result information. The evaluation result information 500 illustrated in FIG. 5 includes fields 501 through 504. Field 501 stores an index as an identification number to identify an evaluation result of evaluating machine learning. Field 502 stores a parameter value as a trial parameter used for the machine learning tried by the classification model portion12. Field 503 stores an evaluation value as an evaluation result. The present embodiment assumes the evaluation value to be an error amount representing the magnitude of an error, but is not limited to this example. For example, the evaluation value may represent an accuracy rate or a recall rate. Field 504 stores a space ID to identify an area to which the trial parameter belongs in the parameter space.

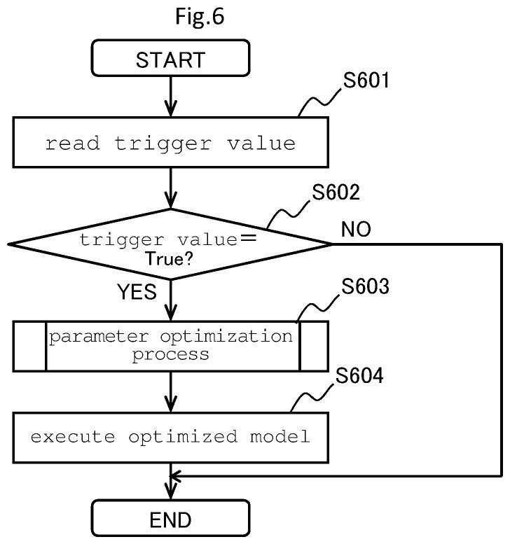

FIG. 6 is a flowchart illustrating a process performed by the information processing device 1.

The optimization portion 13 reads a trigger value as a value of the trigger 21 (step S601) and determines whether the trigger value is “True” indicating the execution of the parameter optimization process (step S602).

If the trigger value is “True,” the optimization portion 13 executes the parameter optimization process (step S603). If the trigger value is “False,” the information processing device 1 terminates the process.

The optimized model portion 15 executes an optimization model, classifies the input data 22, and outputs the classification result as the result 23 (step S604). The optimization model is a classification model generated by machine learning through the use of the parameters determined by the optimization portion 13.

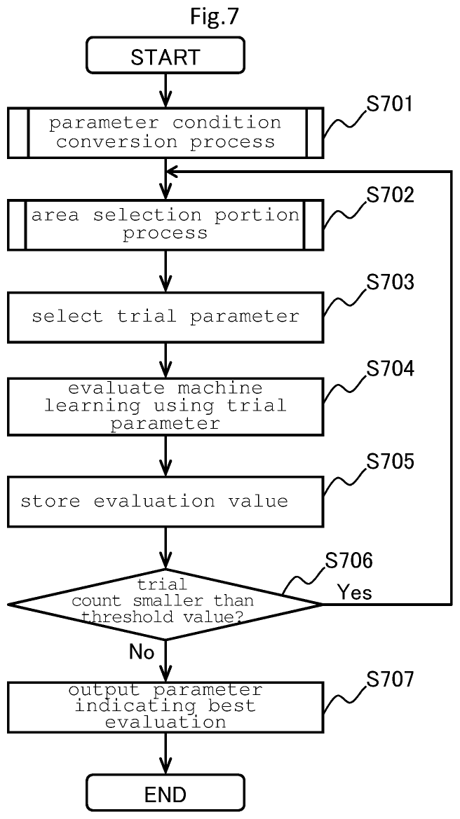

FIG. 7 is a flowchart illustrating the parameter optimization process at step 603 in FIG. 6.

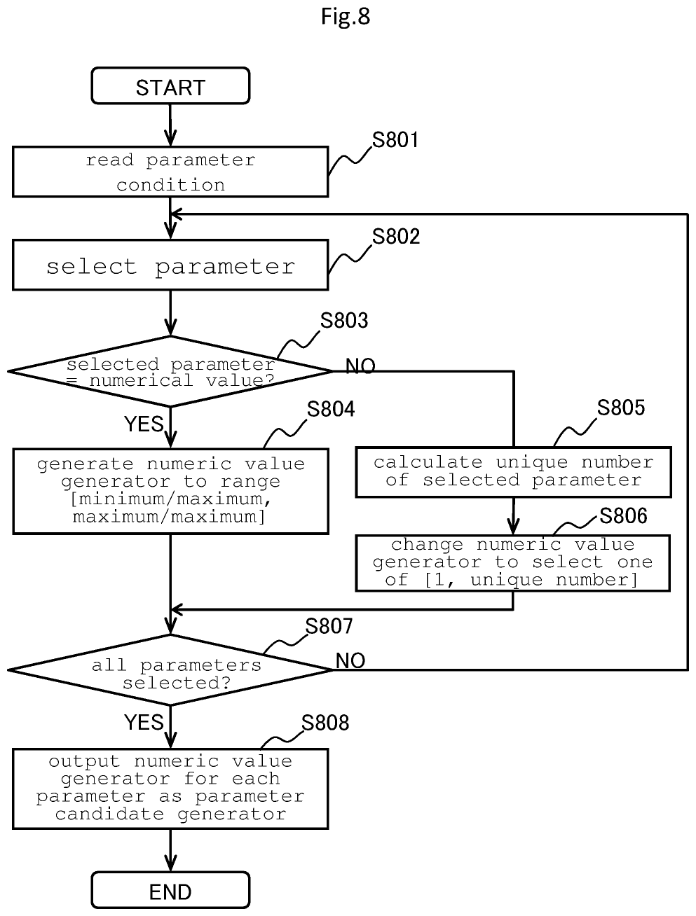

The conversion portion 131 of the optimization portion 13 performs a parameter condition conversion process (see FIG. 8) that generates a candidate parameter generator to generate candidate parameters based on the parameter condition 31 (step S701).

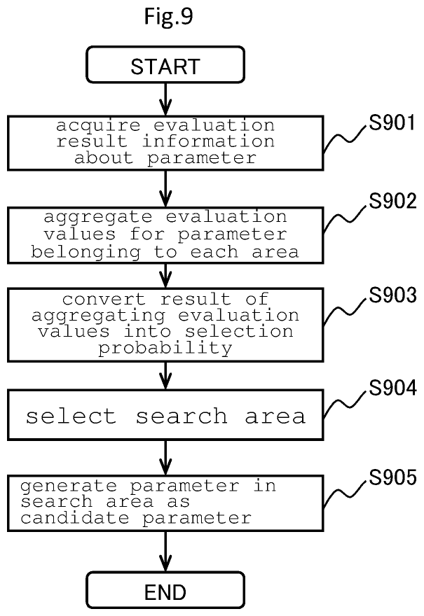

The area selection portion 132 selects one of the areas contained in the parameter space as a search area based on the evaluation result information stored in the evaluation result database 130, then uses the candidate parameter generator generated by the conversion portion 131 to perform an area selection portion process (see FIG. 9) that generates a set of parameters in the search area as a set of candidate parameters (step S702).

The parameter selection portion 133 selects the trial parameter to be set in the classification model from the set of candidate parameters (step S703). The method of selecting the trial parameter is not predetermined and may use a Bayesian optimization method, for example.

The evaluation portion 134 allows the classification model portion 12 to try machine learning based on the trial parameter selected by the parameter selection portion 133 and calculates an evaluation value that evaluates the classification model as a processing result of the machine learning (step S704). The evaluation portion 134 updates the evaluation result information in the evaluation result database 130 based on the trial parameter and the evaluation value (step S705).

The output portion 135 determines whether the number of machine learning trials performed by the classification model portion 12 is smaller than a predetermined threshold value (step S706).

If the number of trials is greater than or equal to the threshold value, the output portion 135 outputs output information corresponding to the evaluation result information stored in the evaluation result database 130 (step S707). The output information includes the trial parameter indicating the best evaluation value as a parameter used for machine learning, for example. If the number of trials is smaller than the threshold value, the process returns to step S702.

FIG. 8 is a flowchart illustrating the parameter condition conversion process at step S701 in FIG. 7.

In the parameter condition conversion process, the conversion portion 131 reads the parameter condition 31 (step S801). The conversion portion 131 selects one of the parameters for machine learning performed by the classification model portion 12 based on the parameter condition 31 (step S802).

The conversion portion 131 determines whether the selected parameter is a numerical value (step S803).

If the selected parameter is a numerical value, the conversion portion 131 generates a numeric value generator that causes a range of generated numeric values to be [minimum/maximum, maximum/maximum] in terms of the selected parameter (step S804). In this case, [a, b] denotes a range between a or greater and b or smaller. The minimum value and the maximum value correspond to the minimum value and the maximum value of the selected parameter. The numerical value generator generates a numerical value corresponding to the selected parameter type (data type).

If the selected parameter is not a numeric value, the conversion portion 131 calculates a unique number, namely, the number of available values for the selected parameter (step S805). The conversion portion 131 generates a numeric value generator that causes a range of generated numeric values to be [1, unique number] in terms of the selected parameter (step S806). If a duplicate exists in the available values for the selected parameter indicated by the parameter condition 31, the conversion portion 131 calculates the number of values excluding the duplicated value as the unique number.

The conversion portion 131 determines whether all the parameters are selected (step S807).

If all parameters are not selected, the conversion portion 131 returns to step S802. If all the parameters are selected, the conversion portion 131 generates a set of numeric value generators for each parameter as a parameter candidate generator (step S808) and terminates the process.

FIG. 9 is a flowchart illustrating the area selection portion process at step S702 in FIG. 7.

In the area selection portion process, the area evaluation portion 201 of the area selection portion 132 acquires the evaluation result information from the evaluation result database 130 (step S901). Based on the evaluation result information, the area evaluation portion 201 calculates an area evaluation value, namely, an aggregate value of the evaluation values for the parameter belonging to the area corresponding to each area in the parameter space (step S902). The aggregate value denotes an average value, a total value, and a maximum value for the evaluation values, for example. The aggregate value is not limited to this example.

The probabilistic area selection portion 202 converts the area evaluation value for each area into the selection probability of selecting that area (step S903). For example, the probabilistic area selection portion 202 increases the selection probability for an area as the area increases the area evaluation value. It is favorable that the probabilistic area selection portion 202 applies the selection probability larger than 0 even to an area indicating the smallest area evaluation value.

The probabilistic area selection portion 202 then selects one of the areas as a search area according to the selection probability (step S904).

The candidate parameter generating portion 203 uses the candidate parameter generator generated by the conversion portion 131 to generate a set of parameters belonging to the search area as a set of candidate parameters (step S905) and terminates the process.

The above-described area selection portion process may allow the selection probability of each area to incorporate the number of searches in which each area has been selected as the search area. For example, the probabilistic area selection portion 202 may correct the aggregate value based on the number of searches so that the aggregate value increases as the number of searches decreases. The selection probability may be directly corrected so that the selection probability increases as the number of searches decreases.

According to the present embodiment, the multiple areas in the parameter space correspond to subspaces acquired by dividing a low-dimensional space resulting from order reduction of the parameter space through the use of locality sensitive hashing.

Specifically, suppose the number of parameters is defined as D and parameters as θ1 through θN. Then, an order-reduced space is generated from components of an M-dimensional vector calculated as the product of a D-dimensional vector (θ1, θ2, . . . , θN) and a D×M matrix generated from random numbers. Each component is binarized to 0 or 1 and is thereby coded. The order-reduced space is divided based on a code pattern.

The coding is performed by assuming a positive component of the M-dimensional vector to be 1 and a negative component of the M-dimensional vector to be 0, for example. When M is 2, for example, the order-reduced space is divided into areas whose codes are [0, 0], [0, 1], [1, 0] and [1, 1], respectively.

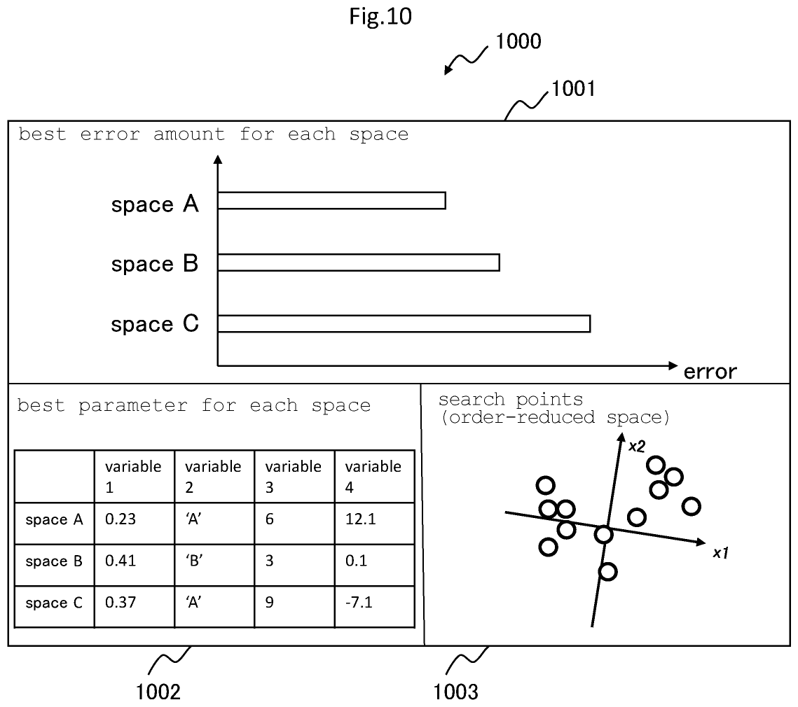

FIG. 10 is a diagram illustrating a display screen the output portion 135 displays on the display portion 14. A display screen 1000 illustrated in FIG. 10 shows an intermediate result displayed during the optimization process and includes a first frame 1001 through a third frame 1003. The example of FIG. 10 includes four variables 1 through 4 as parameters. The parameter space is divided into four spaces A through D, resulting from dividing a two-dimensional order-reduced space. An error amount is shown as the evaluation value of the classification model.

For each subspace, the first frame 1001 shows the best error amount, namely, the minimum value of the error amount corresponding to the trial parameter belonging to that subspace. The error amount corresponding to the trial parameter applies to the classification model based on the machine learning tried through the use of the trial parameter. In FIG. 10, a horizontal bar graph represents the best error amounts of spaces A through C out of spaces A through D.

For each subspace, the second frame 1002 shows a space-based best parameter (best parameter per space), namely, a trial parameter that belongs to the subspace and is given the smallest best error amount to provide the best evaluation value. FIG. 10 uses a table format to represent the space-based best parameters of spaces A through C out of spaces A through D.

The third frame 1003 shows the trial parameters belonging to each subspace.

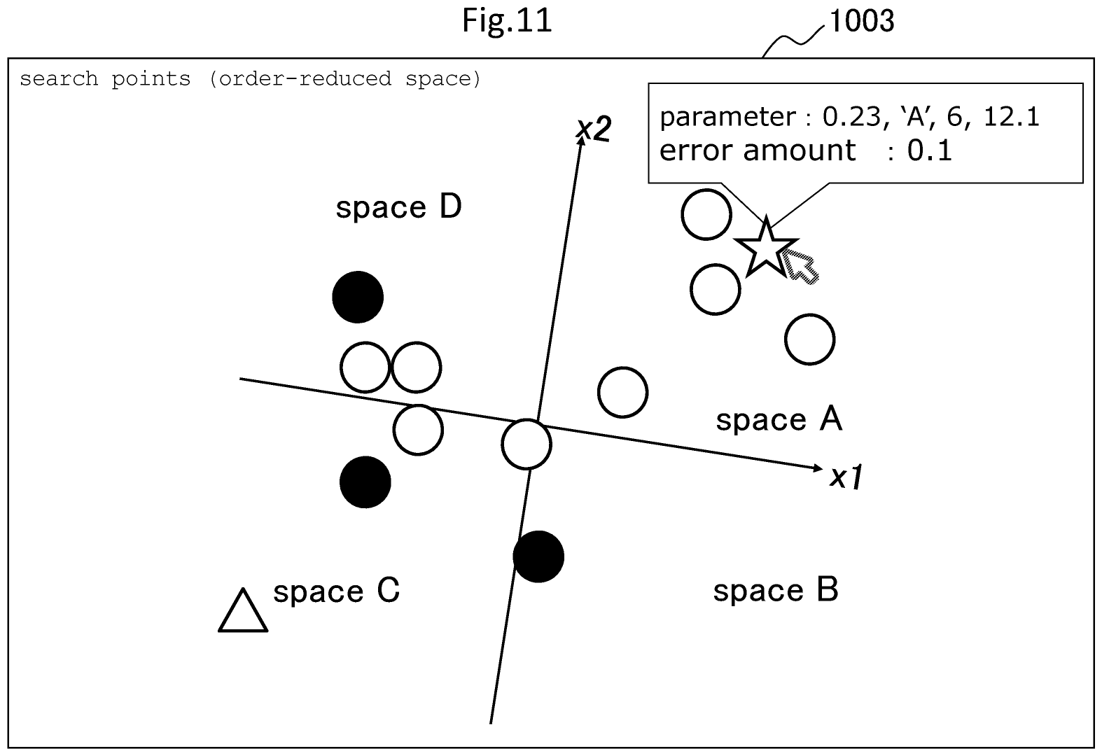

FIG. 11 is a partially enlarged view of the third frame 1003. The third frame 1003 illustrated in FIG. 11 plots the trial parameters on the two-dimensional order-reduced space. The example illustrated in FIG. 11 uses x1 and x2 as coordinate axes of the order-reduced space. Spaces A through D correspond to the areas where coded values of the coordinates (x1, x2) are [0, 0], [0, 1], [1, 0] and [1, 1], respectively.

In FIG. 11, a star (⋆) indicates the best parameter. A black circle (•) indicates a space-based best parameter other than the best parameter. A white circle (∘) indicates a trial parameter other than the best parameter and space-based best parameter.

The parameter optimization process may enable the user to specify the trial parameter. In the example of FIG. 11, coordinates are specified on the order-reduced space, and thereby the trial parameter is specified. The trial parameter specified by the user is indicated by a triangle (Δ). The user may specify the plotted trial parameter to display information about the trial parameter. The example in FIG. 11 shows the specific value of the specified trial parameter and the evaluation value corresponding to the specified trial parameter.

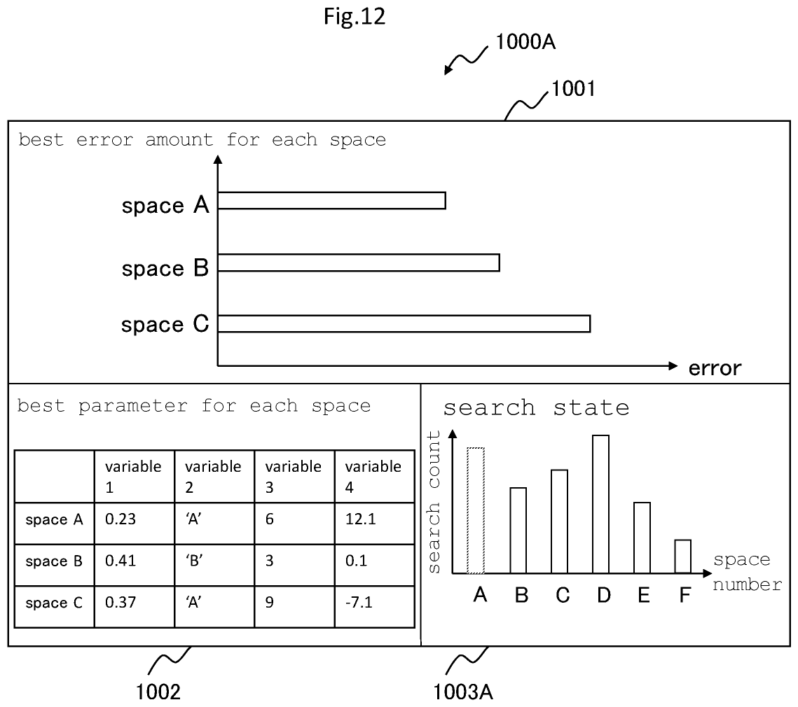

FIG. 12 is a diagram illustrating another example of the display screen. A display screen 1000A illustrated in FIG. 12 corresponds to an example of reducing the parameter space to an order-reduced space of three or more dimensions and differs from the display screen 1000 illustrated in FIG. 10 in that the third frame 1003 is replaced by a third frame 1003A. In the example of FIG. 12, the parameter space is divided into subspaces A through F.

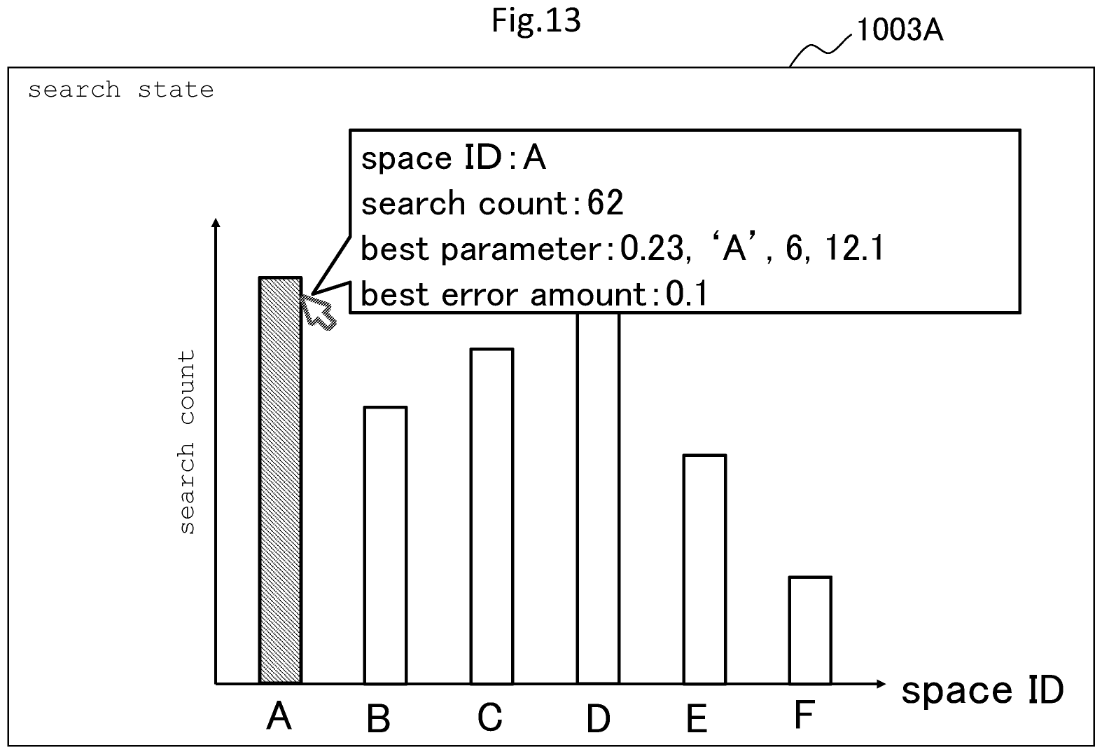

FIG. 13 is an enlarged view of the third frame 1003A. In FIG. 13, a bar graph shows, for each subspace, the number of searches for the subspace selected as the search area. In the example of FIG. 13, the hatched bar corresponds to the subspace including the best parameter. The user may specify a bar in the bar graph to display information about the subspace corresponding to that bar. The illustrated example includes the space ID of the subspace corresponding to the specified bar; the number of searches for the subspace selected as the search area; the space-based best parameter of that subspace; and the best error amount as an error amount of the space-based best parameter for that subspace.

The examples of FIGS. 12 and 13 may also enable the user to specify the trial parameter. For example, the user may specify any one of the bars of the bar graph in the third frame 1003A to select the trial parameter that is any of the parameters belonging to the subspace corresponding to that bar.

The above-described information processing device 1 uses hyperparameters as parameters for machine learning as information processing. However, the feature quantity may be used as a parameter for machine learning, for example. In this case, the information processing device 1 determines the feature quantity used for machine learning from multiple types of feature quantities, for example.

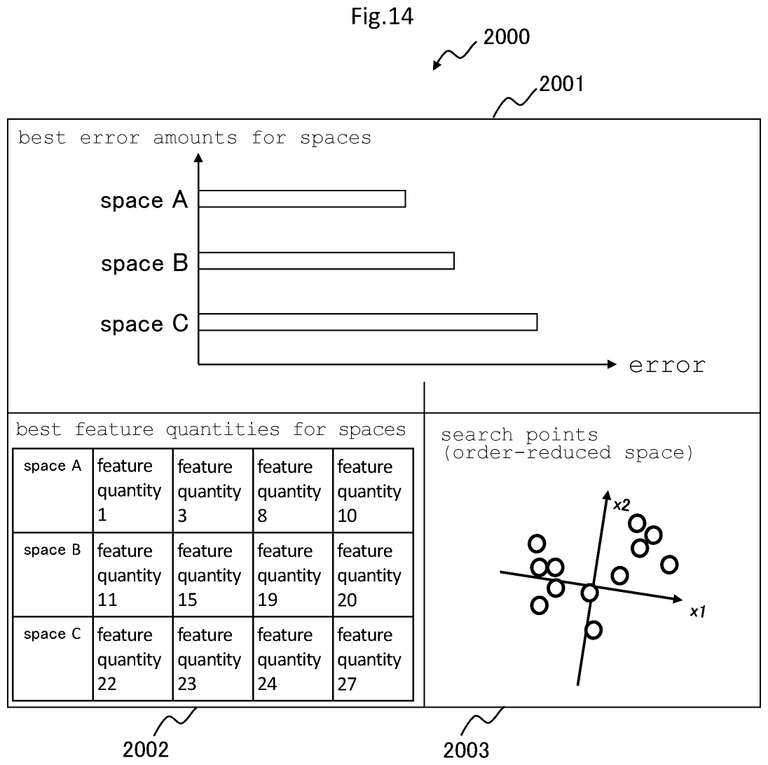

FIG. 14 is a diagram illustrating the display screen when the parameter uses a feature quantity. The display screen 2000 illustrated in FIG. 14 includes a first frame 2001 through a third frame 2003. The example of FIG. 14 includes 100 physical quantities as parameters. The parameter space is divided into four spaces A through D resulting from the division of the two-dimensional order-reduced space. The error amount is shown as the evaluation value of the classification model.

The first frame 2001 shows, for each subspace, the best error amount as the minimum value of the error amount corresponding to the trial parameter belonging to that subspace. The error amount corresponding to the trial parameter applies to the classification model based on the machine learning tried through the use of the trial parameter. In FIG. 10, a horizontal bar graph shows the best error amounts of spaces A through C out of spaces A through D.

The second frame 2002 shows, for each subspace, the trial parameter that belongs to that subspace and indicates the smallest best error amount, namely, the best evaluation value.

The third frame 2003 shows the trial parameters belonging to the subspace for each subspace.

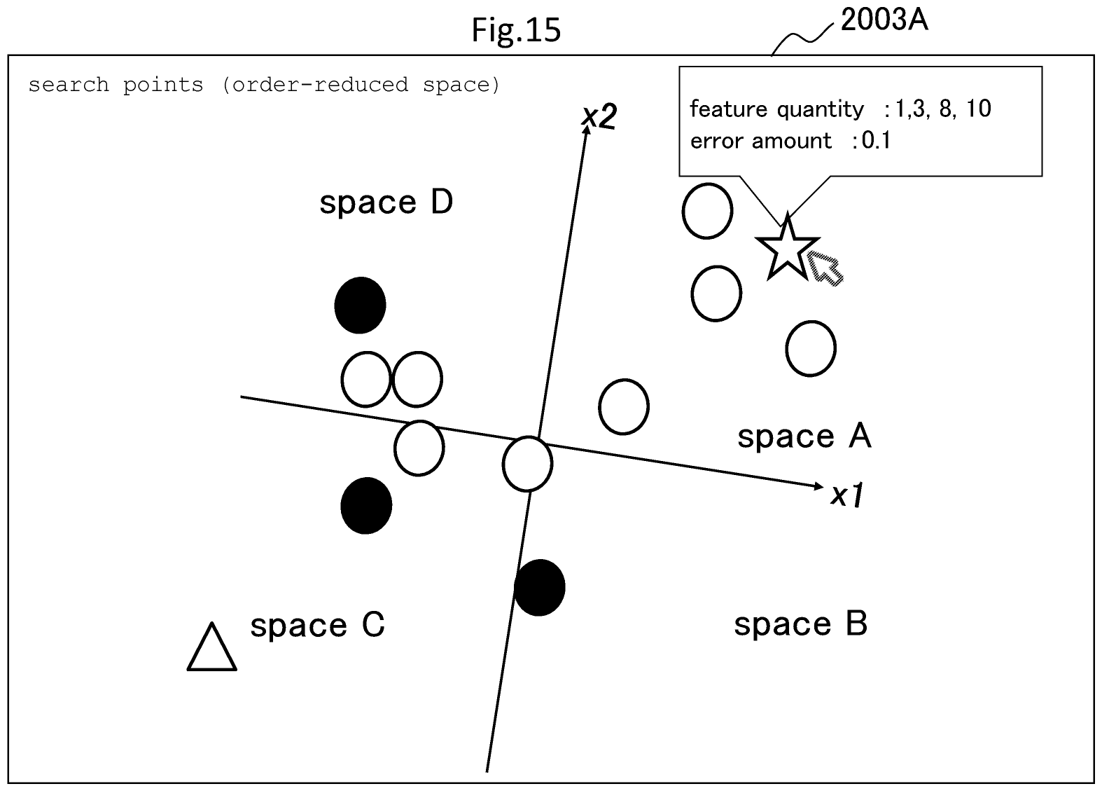

FIG. 15 is an enlarged view of the third frame 2003. The third frame 2003 illustrated in FIG. 15 differs from the third frame 1003 illustrated in FIG. 11 in the information displayed when the user specifies a plotted trial parameter. The example of FIG. 15 assumes the trial parameter to be specified and, as the specified trial parameter, shows a set of feature quantities used for the classification model and the evaluation value corresponding to the set of the feature quantities.

As described above, according to the present embodiment, the optimization portion 13 selects the search area, namely, one of the multiple subspaces contained in the parameter space composed of multiple parameters based on the evaluation result information indicating the evaluation value that evaluates a processing result of information processing based on each trial parameter by using the trial parameter. The optimization portion 13 allows the classification model portion 12 to perform information processing using the trial parameter, namely, any one of the parameters belonging to the search area. The optimization portion 13 repeats the search process to update the evaluation result information based on the processing result of the information processing. As a result, a search area to search for parameters in the parameter space is selected based on the evaluation value that evaluates the processing result of information processing using the parameters belonging to that area. It is possible to more efficiently search for parameters.

According to the present embodiment, the optimization portion 13 provides the selection probability for each of the multiple subspaces based on the evaluation result information and selects the search area according to the selection probability. This makes it possible to more appropriately select the search area and more efficiently search for parameters.

According to the present embodiment, the optimization portion 13 calculates the aggregate value for each subspace based on the evaluation result information. The aggregate value aggregates the evaluation values corresponding to the trial parameters belonging to the subspace. The optimization portion 13 provides the selection probability based on the aggregate value. This makes it possible to more appropriately select the search area and more efficiently search for parameters.

According to the present embodiment, the optimization portion 13 provides the selection probability based on the number of searches to select the search area in each subspace. This makes it possible to select a less frequently searched area as the search area and more efficiently search for parameters.

According to the present embodiment, the subspace is generated by dividing an order-reduced space resulting from the order reduction of the parameter space. In this case, each subspace can be set appropriately.

According to the present embodiment, the optimization portion 13 repeats the search process a predetermined number of times and then determines an available parameter based on the evaluation result information. Therefore, it is possible to appropriately find the parameters used for information processing.

According to the present embodiment, the optimization portion 13 outputs a display screen based on the evaluation result information. The display screen shows the evaluation information comparable to the evaluation value corresponding to the trial parameter belonging to each of the subspaces. Therefore, it is possible to recognize the search status of each subspace.

The above-described embodiment of the present disclosure provides examples to explain the present disclosure and is not intended to limit the scope of the present disclosure only to the embodiment. One of ordinary skill in the art can implement the present disclosure in various other aspects without departing from the scope of the present disclosure.

The predetermined information processing is not limited to machine learning and may apply to simulation, for example.

What is claimed is:

1. An information processing device to search for an available parameter used for predetermined information processing, comprising:
an information processing portion to perform the information processing; and
a search portion that selects a search area, namely, any of a plurality of subspaces included in a parameter space comprised of a plurality of parameters based on evaluation result information indicating an evaluation value to evaluate a processing result of the information processing based on each trial parameter by using the trial parameter, allows the information processing portion to perform the information processing by using any of parameters belonging to the search area as the trial parameter, and repeats a search process to update the evaluation result information based on a processing result of the information processing.

2. The information processing device according to claim 1,
wherein the search portion provides a selection probability for each of the subspaces based on the evaluation result information and selects the search area, according to the selection probability.

3. The information processing device according to claim 2,
wherein, the search portion calculates an aggregate value for each of the subspaces based on the evaluation result information, the aggregate value being configured to aggregate evaluation values corresponding to trial parameters belonging to the subspace, and provides the selection probability based on the aggregate value.

4. The information processing device according to claim 3,
wherein the search portion provides the selection probability based on the number of searches to select the search area in each subspace.

5. The information processing device according to claim 1,
wherein the subspace is generated by dividing an order-reduced space resulting from order reduction of the parameter space.

6. The information processing device according to claim 1,
wherein the search portion repeats the search process a predetermined number of times and then determines the available parameter based on the evaluation result information.

7. The information processing device according to claim 1,
wherein the search portion outputs a display screen based on the evaluation result information; and
wherein, for each of the subspaces, the display screen shows evaluation information comparable to an evaluation value corresponding to a trial parameter belonging to the subspace.

8. The information processing device according to claim 1,
wherein the information processing is comparable to machine learning.

9. The information processing device according to claim 8,
wherein the parameter is comparable to a hyperparameter.

10. The information processing device according to claim 8,
wherein the parameter is comparable to a feature quantity.

11. An information processing method of searching for an available parameter used for predetermined information processing performed by an information processing device, comprising the step of:
selecting a search area, namely, any of a plurality of subspaces included in a parameter space comprised of a plurality of parameters based on evaluation result information indicating an evaluation value to evaluate a processing result of the information processing based on each trial parameter by using the trial parameter, performing the information processing by using any of parameters belonging to the search area as the trial parameter, and repeating a search process to update the evaluation result information based on a processing result of the information processing.
